(19) United States
(12) Patent Application Publication
(10) Pub. No.: US 2005/0244048 A1
(43) Pub. Date: Nov. 3, 2005

(54) Micro-image examining apparatus

(76) Inventor: Ching-Hsiang Liu, Gueishan Township (TW)

Correspondence Address: PRO-TECHTOR INTERNATIONAL, 20775 Norada Court, Saratoga, CA, 95070-3018, US

(21) Appl. No.: 10/913,859

(22) Filed: Aug. 5, 2004

(30) Foreign Application Priority Data
Apr. 30, 2004 (TW) 93206688

(51) Int. Cl. G06K 9/00

(52) U.S. Cl. 382/141

(57) ABSTRACT

A micro-image examining apparatus includes a conveyor belt for moving at least one object to be examined and a microphotographer including a charge-coupled device camera and a lens for acquiring an image of the object on the conveyor belt and for sending the image of the object to a computer monitor. Thus, the objects to be examined are placed on the conveyor belt and moved synchronously. Instead of conventional one-by-one examination by workers, the objects are examined one by one by the microphotographer. The examining efficiency and the examining accuracy are both improved.

### BACKGROUND OF THE INVENTION

1. Field of the Invention

The present invention relates to a micro-image examining apparatus. In particular, the present invention relates to a micro-image examining apparatus for examining objects for quality control purposes.

2. Description of the Related Art

Quality control is necessary to assure quality of products, and considerable time cost is required for quality control of fine products that is examined one by one by workers. Labor-intensive quality control means expensive cost and low efficiency plus great errors. The present invention is intended to provide an examining apparatus to solve this problem.

### SUMMARY OF THE INVENTION

An object of the present invention is to provide a micro-image examining apparatus for replacing conventional one-by-one examination on objects for quality control purposes, improving the examining efficiency and improving accuracy.

In accordance with an aspect of the present invention, a micro-image examining apparatus comprises a conveyor belt for moving at least one object to be examined and a microphotographer including a charge-coupled device camera and a lens for acquiring an image of the object on the conveyor belt and for sending the image of the object to a computer monitor.

In an embodiment of the invention, the micro-image examining apparatus includes a base, a post fixed on the base, and a supporting member mounted on the post, with the microphotographer being supported by the supporting member. In another embodiment of the invention, the base includes a column fixed on top thereof, and the post is pivotally connected with the column, allowing the post to pivot relative to the column.

The micro-image examining apparatus further includes a first plate, a second plate, a first roller rotatably mounted between the first plate and the second plate, and a second roller rotatably mounted between the first plate and the second plate, with the conveyor belt being mounted around the first roller and the second roller.

In an embodiment of the invention, each of the first plate and the second plate includes an opening, and the base extends through the openings of the first plate and the second plate. In another embodiment of the invention, the base extends from the one of the first plate and the second plate.

In an embodiment of the invention, the microphotographer includes a top lamp above the conveyor belt and a bottom lamp in a space defined by the conveyor belt and aligned with the top lamp. The microphotographer may further include an inclined top lamp attached to the supporting member and extending in a direction at an acute angle with a vertical direction.

The micro-image examining apparatus further includes means for discriminating whether the object is qualified. The micro-image examining apparatus further includes a motor for driving the conveyor belt. Preferably, the conveyor belt is transparent.

In another embodiment of the invention, a fixed track is mounted in a space defined by the conveyor belt and a sliding seat is slidably mounted to the fixed track. A post is fixed on the sliding seat and a supporting member is mounted on the post for supporting the microphotographer.

In an embodiment of the invention, one of the first plate and the second plate includes an auxiliary plate mounted on an upper side thereof. The auxiliary plate includes a plurality of longitudinally spaced slots, and a plurality of adjusting bolts respectively extend through the slots, providing a reference for the object placed on and conveyed by the conveyor belt.

Thus, the objects to be examined are placed on the conveyor belt and moved synchronously. Instead of conventional one-by-one examination by workers, the objects are examined one by one by the microphotographer. The examining efficiency and the examining accuracy are both improved.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a micro-image examining apparatus in accordance with the present invention.

FIG. 2 is an exploded perspective view of a microphotographer of the micro-image examining apparatus in accordance with the present invention.

FIG. 3 is a front view, partly sectioned, of the micro-image examining apparatus in accordance with the present invention.

FIG. 4 is a side view, partly sectioned, of the micro-image examining apparatus in accordance with the present invention.

FIG. 5 is a perspective view of a modified embodiment of the micro-image examining apparatus in accordance with the present invention.

FIG. 6 is perspective view of another modified embodiment of the micro-image examining apparatus in accordance with the present invention.

FIG. 7 is a side view, partly sectioned, of the micro-image examining apparatus in FIG. 6.

FIG. 8 is a perspective view of the micro-image examining apparatus in FIG. 6 in a folded state.

### DETAILED DESCRIPTION OF THE PREFERRED EMBODIMENTS

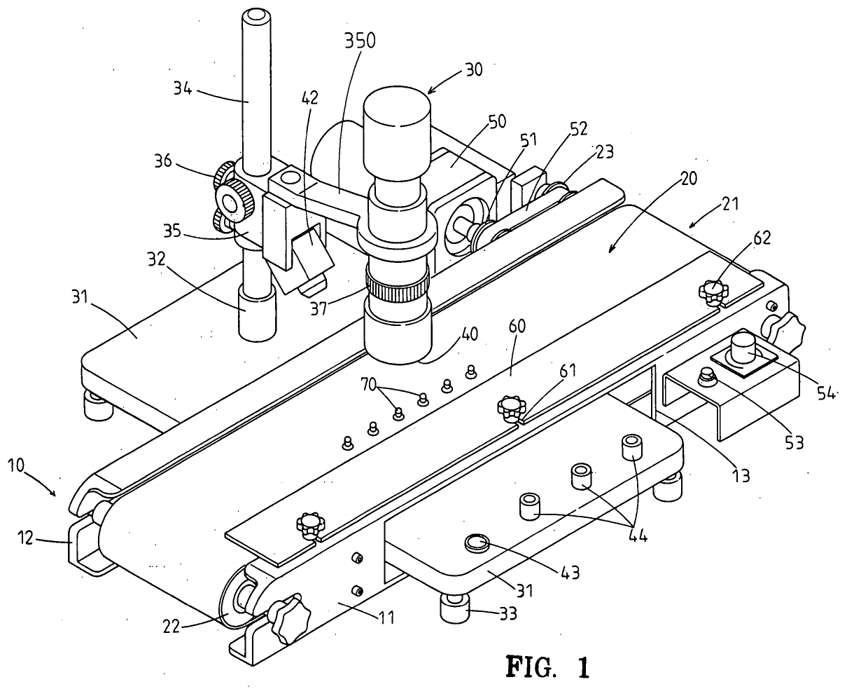

Referring to FIGS. 1 through 4, a micro-image examining apparatus in accordance with the present invention comprises a conveyor belt 20 mounted between a first plate 11 and a second plate 12 of a conveying station 10. The conveyor belt 20 is mounted around a drive roller 21 and a driven roller 22 that are rotatably and respectively mounted between front ends and rear ends of the first plate 11 and the second plate 12. A motor 50 is mounted in the conveying station 10 and includes an output shaft (not labeled) with a pulley 51. An endless belt 52 is mounted around the pulley 51 and another pulley 23 on an end of the drive roller 21. Thus, when the motor 50 turns, the drive roller 21 is turned to move the conveyor belt 20. The conveyor belt 20 may be transparent.

In this embodiment, a power switch 53 for turning the motor 50 on/off and a speed knob 54 for controlling the speed of the motor 50 are mounted to a bracket (not labeled) attached to the front plate 11. An auxiliary plate 60 may be attached to an upper side of the first plate 11. The auxiliary plate 60 includes a plurality of longitudinally spaced slots 61, with adjusting bolts 62 respectively extending through the slots 61 at identical or different positions, providing a reference for objects 70 placed on and conveyed by the conveyor belt 20.

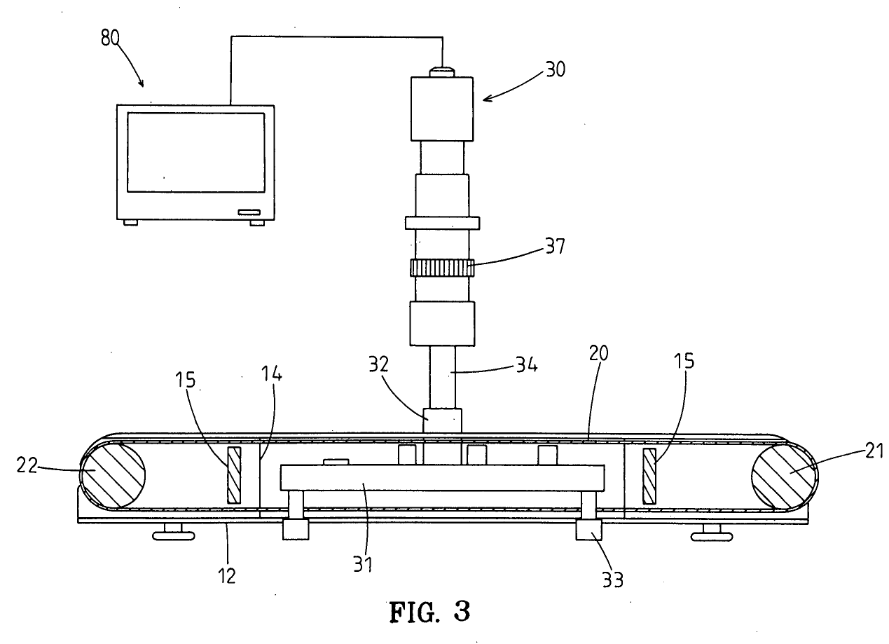

A microphotographer 30 is mounted above the conveyor belt 20 and includes a charge-coupled device (CCD) camera and a lens for acquiring an image of an object 70 and sending the image to a computer monitor 80 (FIG. 3) for examining if there is any defect in the appearance of the object 70 and for discriminating whether the object 70 is a qualified product.

The microphotographer 30 is mounted on a base 31. In this embodiment, the base 31 includes a column 32 fixed on top of the base 31, a post 34 extending upright from the column 32, and a supporting member 35 mounted around the post 34. Of course, the column 32 may be omitted when desired. The supporting member 35 may be turned around the post 34 and slidable along a longitudinal axis of the post 34 to a desired position. Bolts 36 are used to fix the supporting member 35 in place. The supporting member 35 includes an extension or arm 350 for securely holding the microphotographer 30.

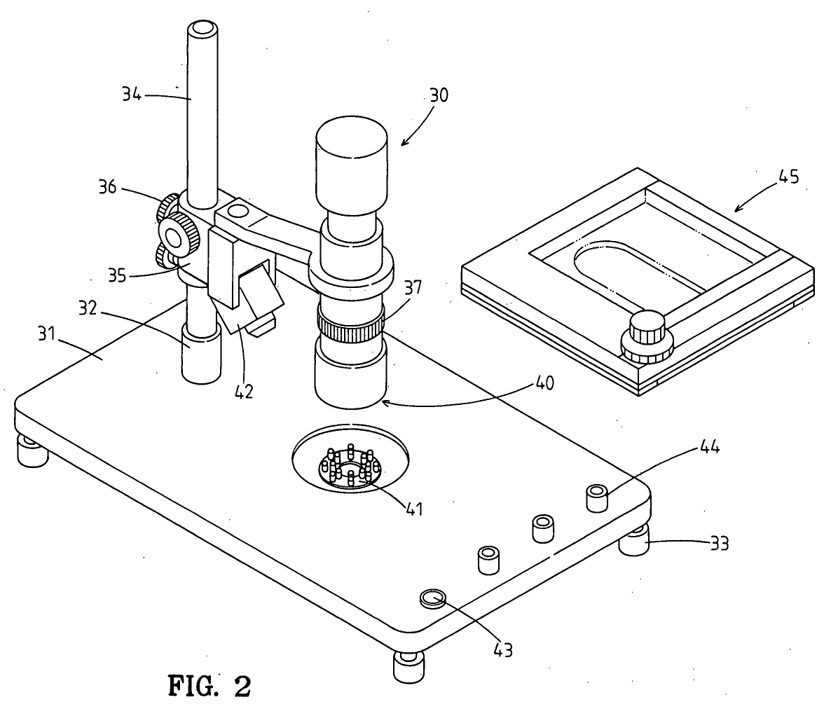

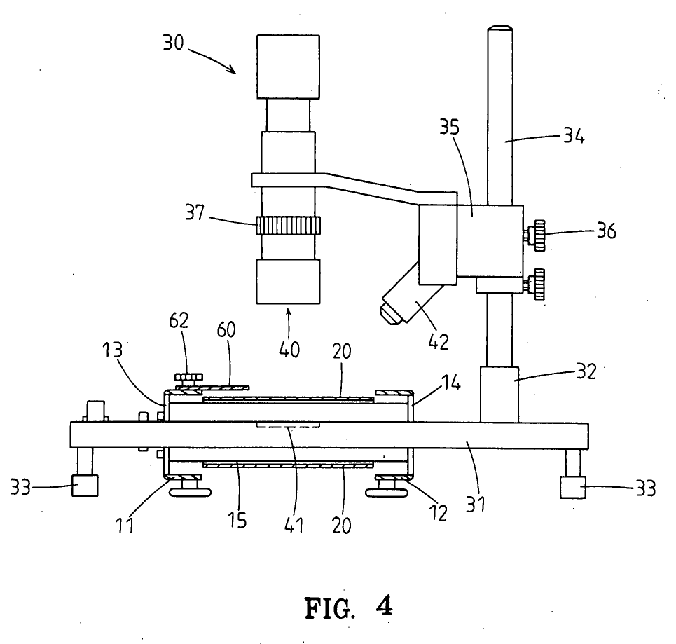

The microphotographer 30 further includes a top lamp 40 above the conveyor belt 20 and a bottom lamp 41 mounted on the base 31, located in a space defined by the conveyor belt 20, and aligned with the top lamp 40, as shown in FIG. 4. The microphotographer 30 may further include an inclined top lamp 42 attached to the supporting member 35 and extending in a direction at an acute angle with a vertical direction. The lamps 40, 41, and 42 provide illumination during examination of the objects 70. Preferably, each of the top lamp 40, the bottom lamp 41, and the inclined top lamp 42 includes annularly arranged light-emitting diodes (LEDs) (FIG. 2). Further, an amplification adjuster 37 may be mounted slightly above the top lamp 40 for adjusting the amplification of the lens.

The base 31 may include a plurality of pads 33. Further, the base 31 extends through openings 13 and 14 respectively in the first and second plates 11 and 12. Thus, a portion of the base 31 is located in the space defined by the conveyor belt 20. Further, switches 43 and 44 for the lamps 40, 41, and 42 may be mounted on an end of the base 31 adjacent to the first plate 11. FIG. 2 shows the microphotographer 30, the base 31 with corresponding elements for supporting the microphotographer 30, and a transparent examination table 45 mounted between the top lamp 40 and the bottom lamp 41. A separate examining apparatus is thus provided.

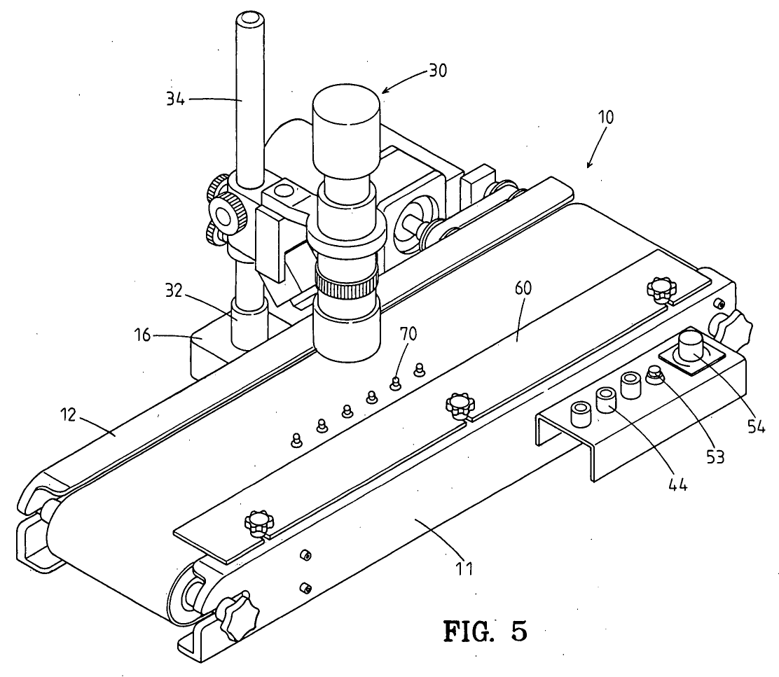

FIG. 5 shows a modified embodiment of the invention, wherein the base 31 in the above embodiment is replaced with an extension 16 extending from the second plate 12, with the post 34 fixed on the extension 16. The switches 44 for turning the lamps 40, 41, and 42 on/off can be mounted to a bracket (not labeled) attached to the first plate 11.

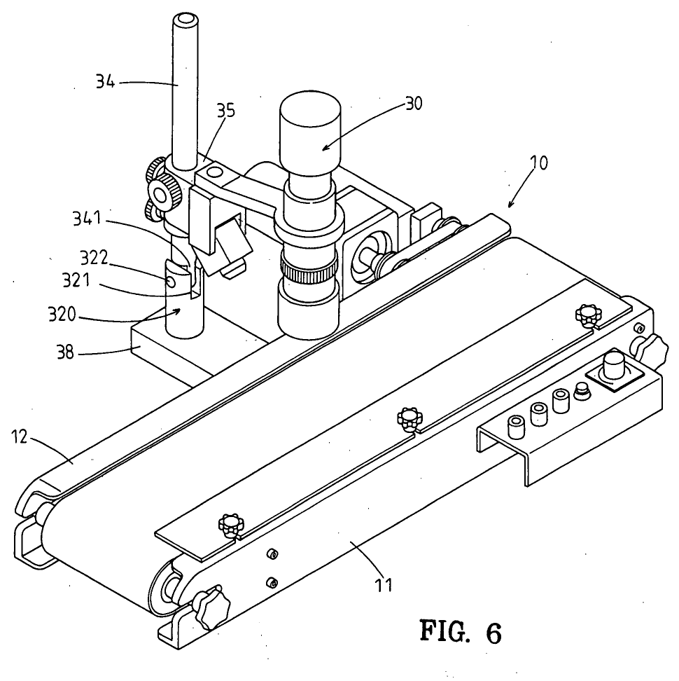

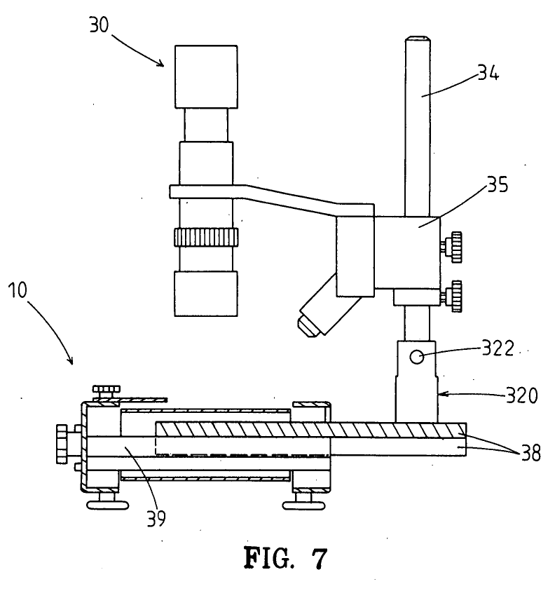

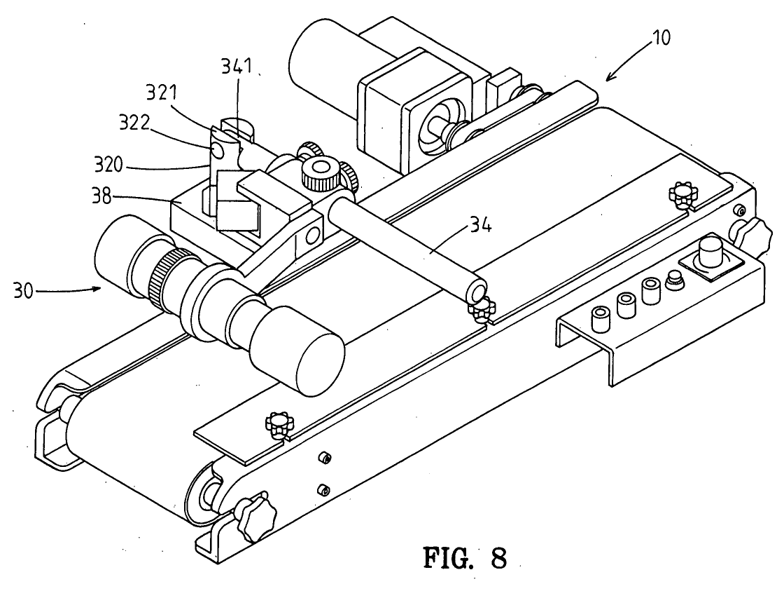

FIGS. 6 through 8 illustrate another modified embodiment of the invention, wherein the post 34 for the microphotographer 30 is mounted on a sliding seat 38, which, in turn, is slidingly mounted on a fixed track 39 in the space defined by the conveyor belt 10. Thus, the longitudinal position of the microphotographer 30 relative to the first and second plates 11 and 12 can be adjusted. Further, the post 34 includes an end 341 that is engaged by a pin 322 with an end 321 of the column (now designated by 320). Thus, the microphotographer 30 may be pivoted to a horizontal, folded position shown in FIG. 8 when not in use.

The objects 70 to be examined are placed on the conveyor belt 20 and moved synchronously. Instead of conventional one-by-one examination by workers, the objects 70 are examined one by one by the microphotographer 30. The examining efficiency and the examining accuracy are both improved.

Although specific embodiments have been illustrated and described, numerous modifications and variations are still possible without departing from the essence of the invention. The scope of the invention is limited by the accompanying claims.

1. A micro-image examining apparatus comprising:
a conveyor belt for moving at least one object to be examined; and
a microphotographer including a charge-coupled device camera and a lens for acquiring an image of said at least one object on the conveyor belt and for sending the image of said at least one object to a computer monitor.

2. The micro-image examining apparatus as claimed in claim 1, with the micro-image examining apparatus further including a base, a post fixed on the base, and a supporting member mounted on the post, with the microphotographer being supported by the supporting member.

3. The micro-image examining apparatus as claimed in claim 1, with the micro-image examining apparatus further including a first plate, a second plate, a first roller rotatably mounted between the first plate and the second plate, and a second roller rotatably mounted between the first plate and the second plate, with the conveyor belt being mounted around the first roller and the second roller.

4. The micro-image examining apparatus as claimed in claim 2, with the micro-image examining apparatus further including a first plate, a second plate, a first roller rotatably mounted between the first plate and the second plate, and a second roller rotatably mounted between the first plate and the second plate, with the conveyor belt mounted around the first roller and the second roller.

5. The micro-image examining apparatus as claimed in claim 4, with each of the first plate and the second plate including an opening, with the base extending through the openings of the first plate and the second plate.

6. The micro-image examining apparatus as claimed in claim 1, with the microphotographer including a top lamp above the conveyor belt and a bottom lamp in a space defined by the conveyor belt and aligned with the top lamp.

7. The micro-image examining apparatus as claimed in claim 2, with the microphotographer including a top lamp above the conveyor belt and a bottom lamp in a space defined by the conveyor belt and aligned with the top lamp.

8. The micro-image examining apparatus as claimed in claim 7, with the microphotographer further including an inclined top lamp attached to the supporting member and extending in a direction at an acute angle with a vertical direction.

9. The micro-image examining apparatus as claimed in claim 1, with the micro-image examining apparatus further including means for discriminating whether said at least one object is qualified.

10. The micro-image examining apparatus as claimed in claim 1, with the micro-image examining apparatus further including a motor for driving the conveyor belt.

11. The micro-image examining apparatus as claimed in claim 1, with the conveyor belt being transparent.

12. The micro-image examining apparatus as claimed in claim 2, with the base including a column fixed on top thereof, with the post being pivotally connected with the column, allowing the post to pivot relative to the column.

13. The micro-image examining apparatus as claimed in claim 3, with a base extending from the one of the first plate and the second plate, with a post being fixed on the base, with a supporting member mounted on the post, with the microphotographer being supported by the supporting member.

14. The micro-image examining apparatus as claimed in claim 1, with micro-image examining apparatus further including a fixed track mounted in a space defined by the conveyor belt, with a sliding seat slidably mounted to the fixed track, with a post being fixed on the sliding seat, with a supporting member mounted on the post, with the microphotographer being supported by the supporting member.

15. The micro-image examining apparatus as claimed in claim 3, with one of the first plate and the second plate including an auxiliary plate mounted on an upper side thereof, the auxiliary plate including a plurality of longitudinally spaced slots, with a plurality of adjusting bolts respectively extending through the slots, providing a reference for said at least one object placed on and conveyed by the conveyor belt.
